(19) United States
(12) Patent Application Publication
(10) Pub. No.: US 2012/0242050 A1
(43) Pub. Date: Sep. 27, 2012

(54) Stroller Wheel Assembly

(75) Inventors: Brady Matthew Schroeder, Milton, GA (US); Thomas M. Perrin, Downingtown, PA (US)

(73) Assignee: Graco Children's Products Inc., Atlanta, GA (US)

(21) Appl. No.: 13/053,129

(22) Filed: Mar. 21, 2011

(51) Int. Cl. B60B 5/00

(52) U.S. Cl. 280/29

(57) ABSTRACT

A stroller wheel assembly has a wheel mount with an interior cavity and defining a generally vertical housing axis. An axle is carried by the wheel mount and a wheel is carried on the axle and rotatable about a rolling axis oriented perpendicular to the housing axis. A leg of a stroller frame has an end section coupled to the wheel mount. A suspension spring has one end borne against a spring stop on the wheel mount within the interior cavity and an opposite end borne against a fixed stop. The spring resiliently supports the wheel mount for movement against a bias force and by the bias force of the spring relative to the leg along the housing axis. The wheel assembly can also be capable of swiveling about the housing axis relative to the leg.

### BACKGROUND

1. Field of the Disclosure

The present invention is generally directed to wheel assemblies for strollers, and more particularly to a stroller wheel assembly with simplified swivel, axle, and/or suspension components and features.

2. Description of Related Art

Strollers are known in the art to include front wheel assemblies that have a swivel function. The wheels typically are mounted on an axle and roll or rotate about a horizontal rolling axis defined by the axle. The swivel function allows the wheel assembly to swivel or rotate about a vertical axis, which changes or varies the rolling direction of the wheels. This can help a user steer and maneuver the stroller around and over obstructions and obstacles during use. The typical swivel assembly has a swivel lock feature, often incorporating a pivotable flipper, reciprocating paddle, or slidable lock lever. The swivel lock can be manipulated between a locked position and a released position. The locked position prevents swiveling, thus locking the rolling direction of the wheels, usually in a straight forward/rearward orientation. The released position permits free swiveling of the wheel assembly about a vertical axis. The components necessary to create this swivel lock function can make manufacture and design of the wheel assembly more complex and expensive and can increase the number of parts required for the assembly.

Stroller wheels typically are mounted for rotation about and roll on a metal or steel axle. A steel axle is a component that is separate and distinct from the remaining components of the wheel assembly, which are often made from plastic materials. Steel typically provides suitable strength, durability, and friction resistance while requiring a generally thin diameter axle size. The steel axle must be strong, durable, and resistant to bending because the axles typically support the entire weight of the stroller, including the seat occupant(s) and any other objects supported by the stroller during use. The wheels touch the ground and are supported on the axles, which in turn support the stroller frame assembly above the ground. Thus, steel is often used to form the axles because it is highly effective and suitable. However, steel is relatively heavy, which adds weight to the stroller product. Also, steel and the base raw materials used to manufacture steel can be relatively expensive.

Many stroller wheel assemblies have an additional wheel suspension system, which allows the wheel and axle to move vertically relative to the frame assembly during use. The suspension system absorbs or dampens vertical motion and shock to the frame assembly created when the wheels hit obstructions and uneven terrain during use. A typical stroller wheel assembly with a swivel function and lock has a spring positioned offset radially from the swivel axis of the wheel assembly. A control arm is often coupled to the rolling axis or the axle at one end and pivotally coupled to another portion of the wheel assembly, such as a wheel mount, at its opposite end. The spring is captured between the control arm and a spring stop also carried on and protruding from part of the mount.

The complex nature of the suspension components further increases the number of parts required to fabricate the wheel assembly and adds complexity to the design and manufacture of the components. The result is a relatively expensive wheel assembly. The suspension spring is often also exposed. Either the spring has a separate cover added to the assembly, which increases cost and complexity, or the spring can become dirty, damaged, or the like from use.

### SUMMARY

In one example according to the teachings of the present invention, a stroller wheel assembly has a wheel mount with an interior cavity and defines a generally vertical housing axis. An axle is carried by the wheel mount and a wheel is carried on the axle and rotatable about a rolling axis oriented perpendicular to the housing axis. A leg of a stroller frame has an end section coupled to the wheel mount. A spring has one end borne against a spring stop on the wheel mount within the interior cavity and an opposite end borne against a fixed stop. The spring resiliently supports the wheel mount for movement against a bias force and by the bias force of the spring relative to the leg along the housing axis.

In one example, the wheel mount can have a housing defining the cavity and the end of the leg can extend through the cavity.

In one example, the stroller wheel assembly can include a spring biased ball device positioned below a bottom edge of a housing of the wheel mount to retain the wheel mount on the end of the leg.

In one example, the wheel mount can have a housing defining the interior cavity and the housing axis and the spring stop can be formed as an annular shoulder within the housing.

In one example, the stroller wheel assembly can have a pair of the wheels arranged parallel and spaced apart from one another.

In one example, the stroller wheel assembly can have a foot rest with an elongate foot platform and a connector at one end. The connector can be coupled to the leg and to the wheel mount.

In one example, the wheel mount can move vertically relative to a connector attaching a foot rest to the leg and along the housing axis. The wheel mount can also be configured to swivel about the housing axis relative to the connector.

In one example, the wheel mount can swivel relative to the leg about the housing axis.

In one example, the end of the leg can extend into the cavity along the housing axis and the wheel mount can move telescopically over the leg along the housing axis.

In one example, the fixed stop can be carried on the leg within the cavity.

In one example according to the teachings of the present invention, a stroller wheel assembly has a wheel mount with a cavity defining a generally vertical housing axis. An axle is carried by the wheel mount and a wheel is carried on the axle and rotatable about a rolling axis oriented perpendicular to the housing axis. A leg of a stroller frame has an end connected to the wheel mount. The wheel mount is capable of swiveling about the housing axis relative to the leg. A spring has one end borne against a housing stop within the interior cavity and an opposite end borne against a fixed stop within the interior cavity. The spring resiliently supports the wheel mount for movement against a bias force and by the bias force of the spring relative to the leg along the housing axis.

In one example, the wheel mount can have a housing defining the cavity and the housing axis. The end of the leg can extend into the cavity along the housing axis whereby the housing can swivel about the end of the leg.

In one example, the wheel mount can have a housing that can move vertically along the end of the leg against and by the bias force of the spring.

In one example, the stroller wheel assembly can have a foot rest with a foot platform and a connector at one end of the foot platform. The connector can be coupled to the leg.

In one example, the wheel mount can have a housing defining the cavity and the housing axis. The housing can be coupled to a connector of a foot rest mounted on the leg such that the housing can swivel about the housing axis relative to the connector.

In one example, the housing can move vertically along the housing axis relative to a connector of a foot rest mounted to the leg.

In one example according to the teachings of the present invention, a stroller wheel assembly has a wheel rotatable about a rolling axis and having a tread surface facing radially outward and a hub surface facing radially inward. A fixed axle is formed as an annulus with a proximal edge connected to a disc, a free edge opposite the proximal edge, and a generally open interior within the annulus. The fixed axle is formed of plastic. The annulus defines an axle surface facing radially outward. The wheel is mounted on the annulus such that the axle surface is borne against the hub surface. The wheel is rotatable about the rolling axis relative to the axle surface.

In one example, a diameter of the axle surface can be about equal to or grater than one half the diameter of the tread surface.

In one example, the stroller wheel assembly can have a plurality of grooves formed in and circumferentially around the axle surface on the annulus.

In one example, the annulus of the fixed axle can have a chamfered leading edge and can have at least one relief slot formed into the leading edge to assist in snapping the wheel onto the fixed axle.

In one example, the stroller wheel assembly can incorporate the above-noted plastic fixed axle and the wheel mount can swivel about a leg of a stroller frame as noted above.

In one example, the stroller wheel assembly can incorporate the above-noted plastic fixed axle and the wheel mount can move vertically relative to a leg of the stroller frame against and by a bias force of a spring as noted above.

In one example, the stroller wheel assembly can incorporate the above-noted plastic fixed axle and the wheel mount can swivel about a leg of a stroller frame as noted above and the wheel mount can move vertically relative to a leg of the stroller frame against and by a bias force of a spring as noted above.

### BRIEF DESCRIPTION OF THE DRAWINGS

Objects, features, and advantages of the present invention will become apparent upon reading the following description in conjunction with the drawing figures, in which:

FIG. 1 shows a rear perspective view of part of a dual wheel assembly for a stroller and constructed in accordance with the teachings of the present invention.

FIG. 2 shows a side perspective view of the dual wheel assembly shown in FIG. 1.

FIG. 3 shows a front and side perspective view of a prior art stroller wheel assembly.

FIG. 4 shows a front and side perspective view of one example of stroller wheel system incorporating two of the dual wheel assembles shown in FIGS. 1 and 2 and constructed in accordance with the teachings of the present invention.

FIG. 5A shows an exploded cross section view of one side of the dual wheel assembly shown in FIG. 4.

FIG. 5B shows a cross section of a bottom portion of the one side of the dual wheel assembly after assembly,

FIG. 6 shows a perspective view from one side of one example of a single wheel assembly for a stroller and constructed in accordance with the teachings of the present invention.

FIG. 7 shows the single wheel assembly shown in FIG. 6 from the opposite side.

FIG. 8 a perspective exploded view of the single wheel assembly shown in FIGS. 6 and 7.

FIG. 9 shows a cross section taken along line 9-9 of the single wheel assembly shown in FIG. 6.

FIG. 10 shows a perspective view of another example of a dual wheel assembly for a stroller and constructed in accordance with the teachings of the present invention.

FIG. 11 shows another alternate perspective view of the dual wheel assembly shown in FIG. 10.

FIG. 12 shows a perspective exploded view of the dual wheel assembly shown in FIGS. 10 and 11.

FIG. 13 shows a cross section taken along line 13-13 of the dual wheel assembly shown in FIG. 11.

### DETAILED DESCRIPTION OF THE DISCLOSURE

The disclosed stroller wheel assemblies solve or improve upon one or more of the above-noted and/or other problems and disadvantages with prior known stroller wheel assemblies. In one example, the disclosed stroller wheel assemblies can incorporate a suspension spring directly in alignment with a swivel axis of the assembly. In one example, the suspension spring can be housed within a cavity of the wheel assembly. In one example, the disclosed stroller wheel assemblies can swivel about a vertical axis while reducing the number of parts typically employed to incorporate a swivel function. In one example, the disclosed stroller wheel assemblies can incorporate both the simplified wheel suspension and the swivel function while utilizing fewer parts than a conventional stroller wheel assembly.

In one example, the disclosed stroller wheel assemblies eliminate the steel axle of a typical stroller wheel assembly. In one example, the disclosed stroller wheel assemblies have a large diameter axle formed of plastic, which provides suitable strength and durability to inhibit deformation during use while eliminating the need for the use of steel. In one example, the disclosed stroller wheel assemblies have a large diameter hollow axle to reduce the amount of plastic material necessary to create the axle. In one example, the disclosed stroller wheel assemblies incorporate such a large diameter axle integral to the wheel mount structure. In one example, the disclosed stroller wheel assemblies can incorporate the large plastic axle aspect of the invention into an assembly that also utilizes the above-noted suspension spring and/or simplified swivel function. These and other objects, features, and advantages of the present invention will become apparent to those having ordinary skill in the art upon reviewing this disclosure.

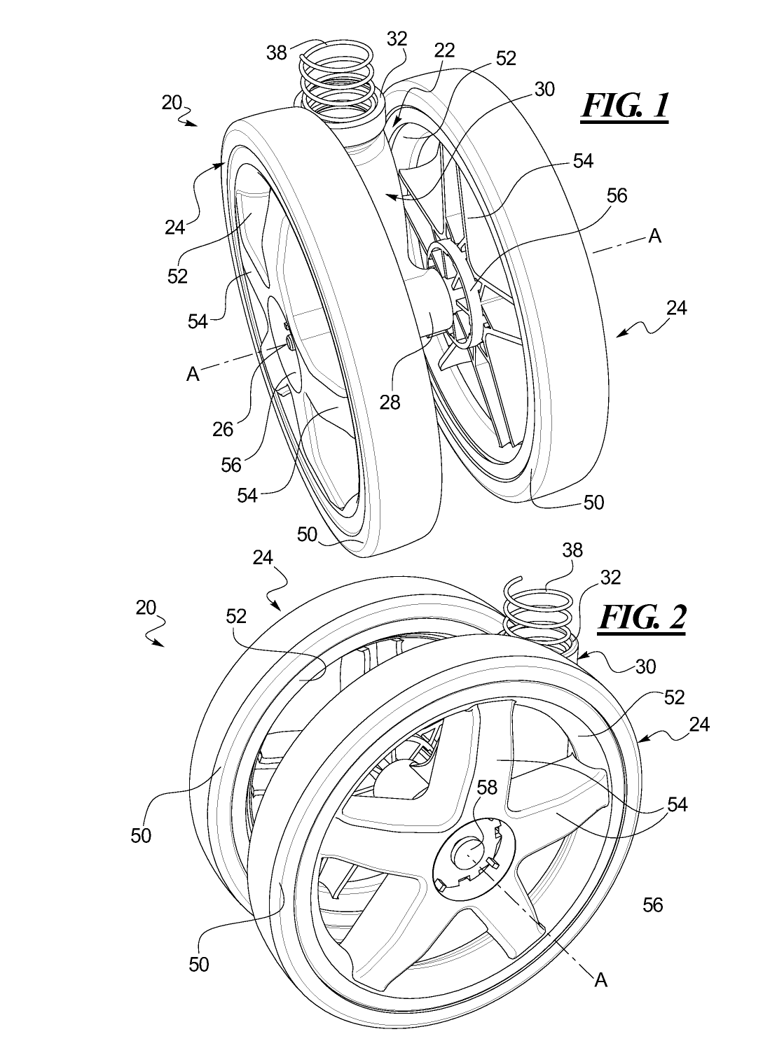

Turning now to the drawings, FIGS. 1 and 2 show one example of a dual wheel assembly 20 for a stroller and constructed in accordance with the teachings of the present invention. As is known in the art, a typical stroller has a frame assembly and an occupant seat supported by the frame assembly. The typical stroller can also optionally include various other features, such as a collapsible or foldable frame structure, a second seat, a movable or adjustable handle assembly, a standing platform, a storage basket, cup holders, storage trays, storage receptacles, and the like. The typical stroller also has a plurality of wheels that support the frame assembly on the ground. Many strollers have a pair of front legs, a pair of rear legs, one or more wheels at or near the lower end of each front leg, and one or more wheels at or near the lower end of each rear leg. The basic stroller components are not disclosed or described herein in order to simplify the description of the invention. The overall configuration and construction of a stroller utilizing the various stroller wheel assemblies disclosed and described herein can vary considerably within the spirit and scope of the invention. In addition, the stroller wheel assemblies disclosed and described herein in can be incorporated as a front wheel assembly or rear wheel assembly of a stroller, if desired and functional as such.

As shown in FIGS. 1 and 2, the dual wheel assembly 20 generally has a wheel mount 22 supporting a pair of parallel, spaced apart wheels 24. The wheels 24 are coupled to the mount 22 for rotation about a horizontal rolling axis A. An axle 26 extends through an axle bore 28 that is integrally formed as a horizontal through-bore at a lower end of the mount 22. The mount 22 in the disclosed example also has a housing 30 arranged in an upward direction relative to the axle bore 28. The housing 30 in this example has an open top 32 and a hollow interior cavity or space 34 within a generally cylindrical side wall 36. The housing 30 defines a generally vertical housing axis V about which the wheel assembly 20 can swivel during use. As used herein, the terms “housing” and “housing axis” refer generally to a receptacle for a shaft, tube, rod, leg, or the like, and to an axis of the receptacle, respectively, that will orient the object received in the or joined to the housing. A suspension spring 38 is received in the cavity or space 34 and provides the resilient suspension or wheel biasing function of the wheel assembly 20 as described below.

Each of the wheels 24 in this example has a tire 50 mounted to an exterior circumferential surface of a wheel rim 52. The wheel rim 52 is supported by a plurality of radially extending spokes 54, which are connected at one end to the rim and at an opposite end to a wheel hub 56. The hub 56 is axially aligned with the rolling axis A and the spokes 54 radiate outward from the hub. In the disclosed example, the hub 56, spokes 54, and rim 52 are formed as an integral plastic molded structure. The tire 50 can also be integrally molded as a part of the same wheel structure or, in the alternative, can be a separate component added to the rim when assembled. The hub, spokes, and/or rim can also be formed separately and then subsequently assembled, fastened, to one another, welded together, or the like. As will be evident to those having ordinary skill in the art, the configuration and construction of the wheel or wheels 24 can vary without departing from the scope of the present invention.

In a disclosed example, the stroller wheel assembly 20 has a pair of the wheels 24 creating the dual wheel structure. In an alternate embodiment, the wheel assembly 20 could include more than two wheels or only a single wheel, if desired. The wheels 24 in this example are arranged parallel to one another, roll on the same rolling axis A, and are spaced apart from one another by the width of the axle bore 28 on the mount 22. The axle 26 can be inserted through holes (not shown) in the wheel hub 56 of one of the wheels 24, through the axle bore 28, and then through the hub 56 of the second wheel 24 to rotatably attach the wheels 24 to the mount 22. One end of the axle 26 can include a head 58 that prevents the axle from slipping through the first wheel hub and axle bore. An opposite end of the axle 26 can include a spring clip (not shown) or other suitable securing means or device to secure the second wheel and axle in place as is known in the art.

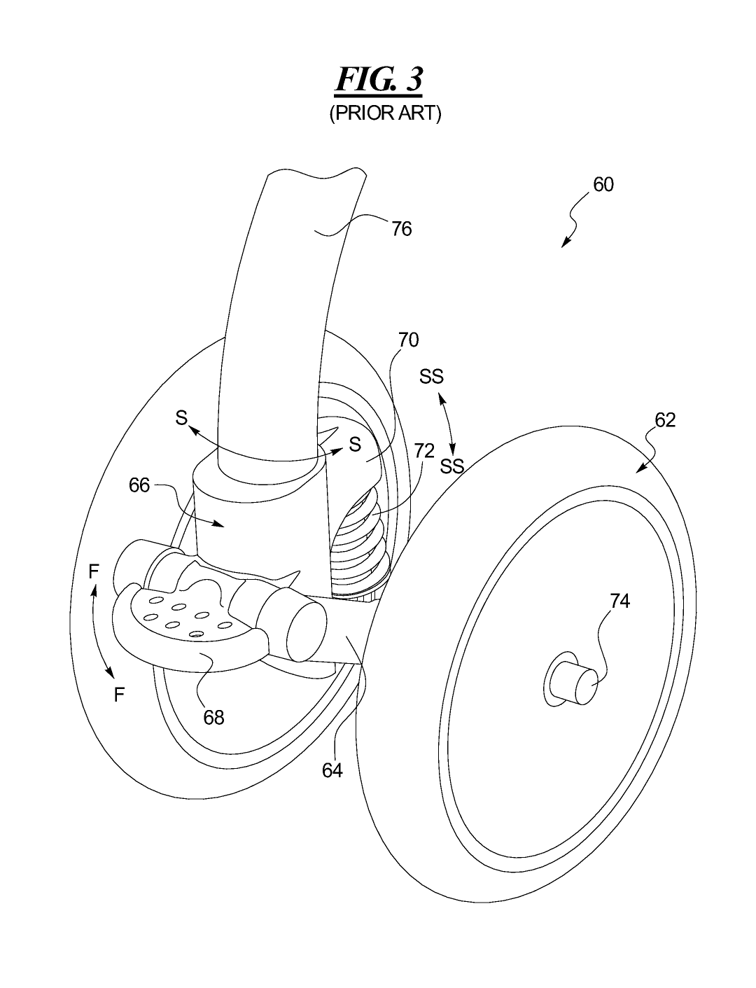

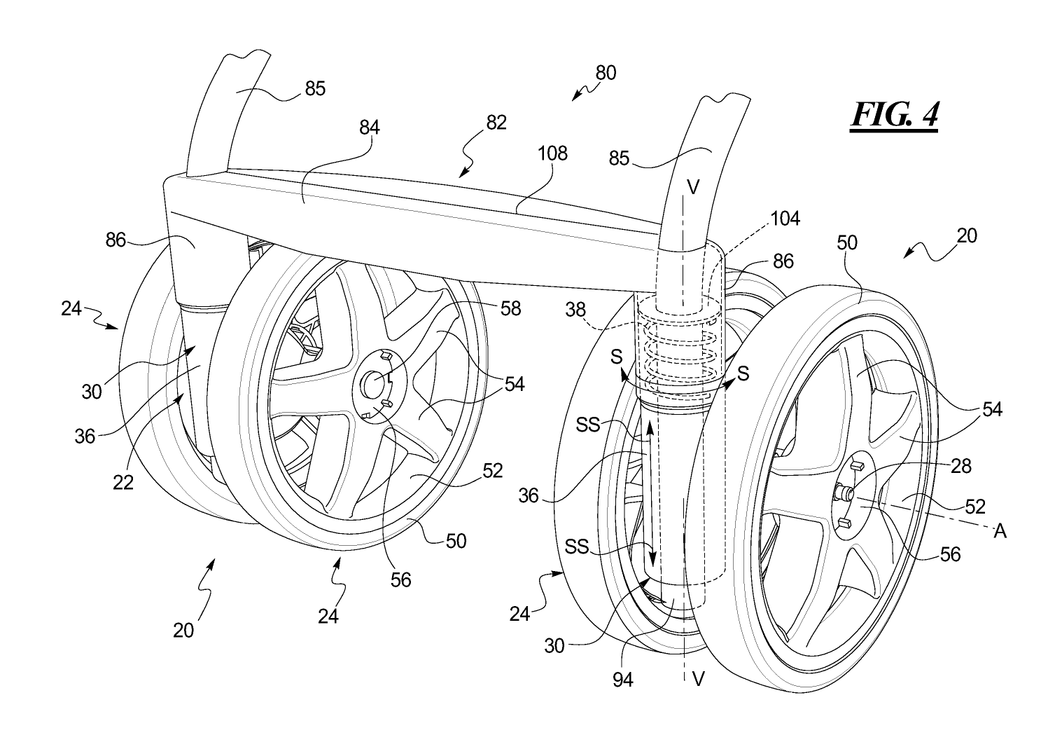

FIG. 3 shows a relatively generic prior art stroller wheel assembly 60, also with a dual wheel construction. The prior art assembly 60 has a pair of wheels 62 carried on a free end of a control arm 64. A proximal end of the control arm 64 is pivotally coupled to a wheel mount 66. A foot pedal 68 protrudes from a front side of the mount 66 and is utilized to either lock or release a swivel lock mechanism (not shown) within the mount 66 as is known in the art. A spring stop 70 protrudes from a rear side of the mount 66. A suspension spring 72 is captured beneath the spring stop 70 between the spring stop and a surface of the control arm 64. The spring 72 biases the control arm 64, and thus the wheels 62 and axle 74, in a downward direction (see arrows SS).

Loads are applied to the wheels during use that will move the wheels upward according to the arrows SS against the spring bias, creating the wheel suspension, i.e., energy absorbing or dampening, function. The complexity of the prior art wheel assembly 60 is apparent from a review of the above description and FIG. 3. The foot pedal 68 can be flipped (see the arrows F) in one direction to lock the wheel assembly 60 and prevent the assembly from swiveling about a frame post or leg 76 (see the arrows S). The foot pedal 68 can be flipped in the opposite direction (see the arrows F) to release the swivel lock to permit swiveling of the assembly 60 about the leg 76 (see the arrows S). Each of the various swivel, swivel lock, and suspension components must be fabricated, assembled, and then maintained over the life of the product. The numerous components can increase the cost of the assembly 60 and present more failure modes that can cause malfunction, damage, or failure to the components caused by use of the prior art stroller.

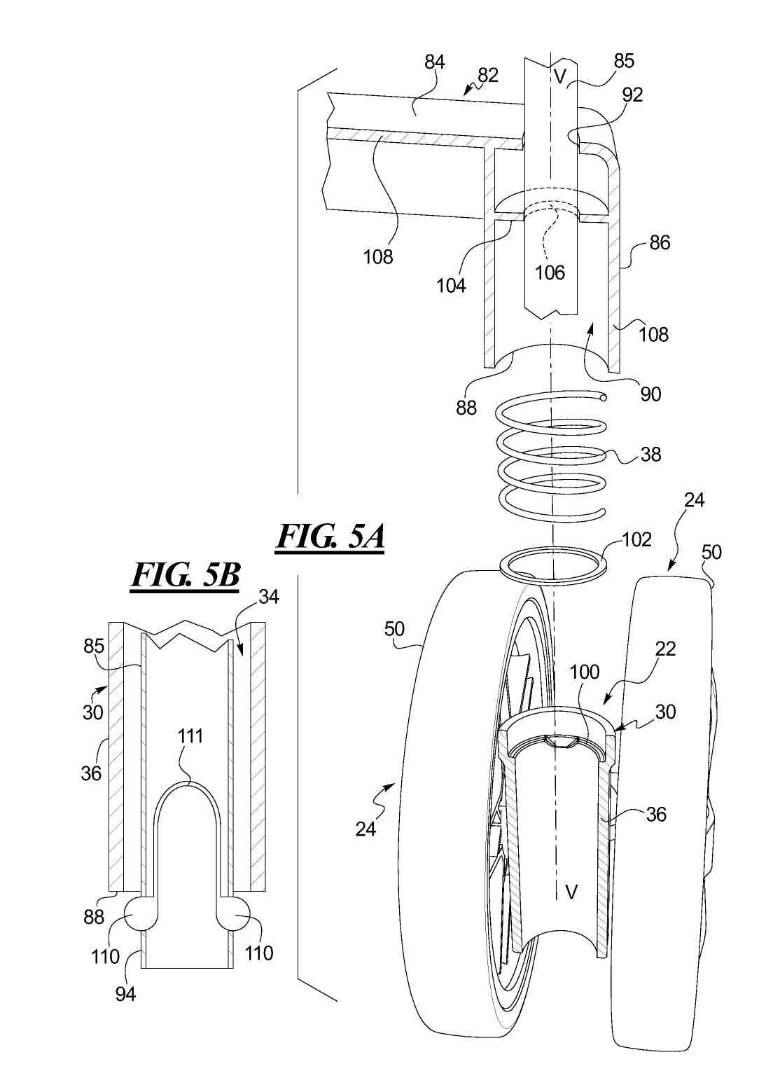

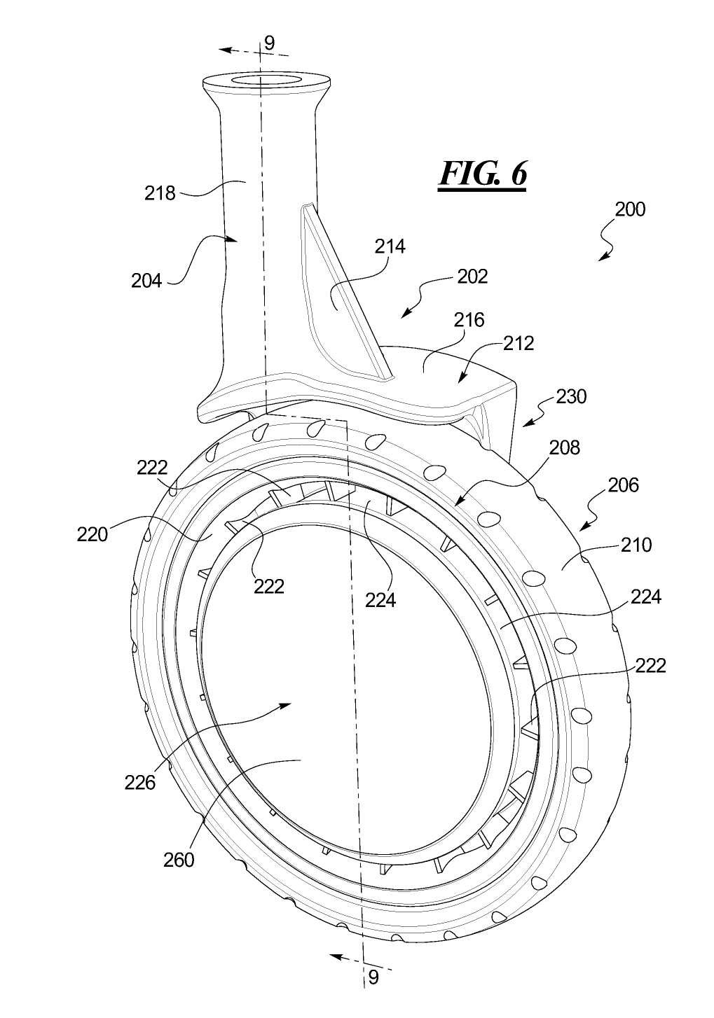

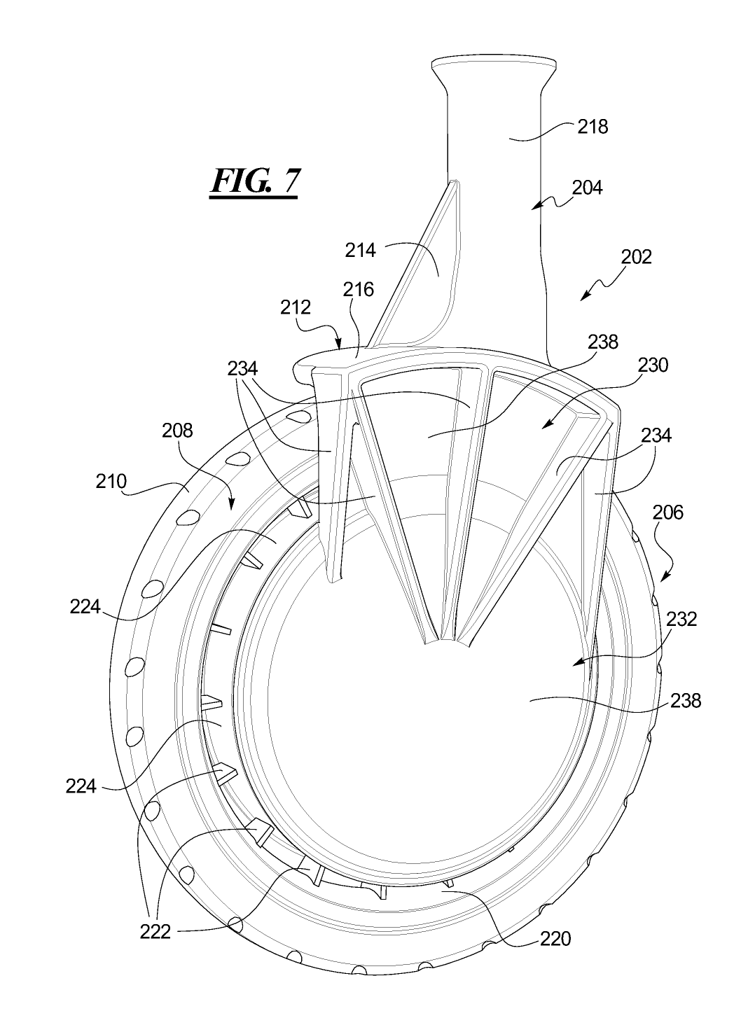

FIG. 4 shows one example of a stroller wheel system 80 incorporating a pair of the dual wheel assemblies 20, one on each side of the stroller frame, according to the present invention. FIG. 5A shows a vertical, exploded cross-section through parts of one of the wheel assemblies 20, though not the wheels, and through a vertical center of the wheel mount 22 thereof. Only one side of the wheel system 80 is described herein, the other side being a minor image thereof in this example. The system 80 employs a foot rest 82 positioned so that an occupant of the stroller's seat can rest their feet on the foot rest. The foot rest 82 has a central foot platform 84 that extends laterally between a pair of frame posts, such as front legs 85, of a stroller frame assembly. A connector 86 is carried on each opposed end of the foot platform. Each of the connectors 86 is essentially a cylinder shape having an open bottom 88, an open interior or passage 90 within the cylinder, and a top opening 92 axially aligned with the open interior and the open bottom. A lower end 94 of the front leg 85 is received through its respective connector 86 via the top opening 92 and extends downward through the open interior 90 and open bottom 88. The open bottom 88 of the connector 86 in one example is joined to the housing 30 adjacent the open top 32 forming an elongate cavity therein. The lower end 94 of the front leg 85 is thus also received through the cavity 34 within the housing 30.

In one example, the housing 30 can be telescopically received within the connector 86 and can be rotatable relative thereto about the housing axis V, creating a swivel motion. The housing can then also be slidable lengthwise relative to the connector 86, permitting a suspension motion along the vertical axis V.

With reference to FIG. 4, the wheel assembly 20 is capable of free swiveling motion in the direction of the arrows S about the vertical housing axis V. Thus, the housing 30 is free to rotate in the direction of the arrows S relative to the fixed connector 86. Though not disclosed or described herein, a swivel lock feature could be added to the wheel assembly 20, if desired, though that would add part cost and complexity to the assembly. The disclosed wheel assembly 20 is also capable of vertical movement along the axis V in the direction of the arrows SS as described in greater detail below.

FIG. 5A shows an exploded view of the various components of the wheel assembly 20 and one side of the system 80. The open top 32 of the housing 30 has a larger diameter than the remaining portion of the body of the housing. Thus, a shoulder 100 is defined near but below the open top 32. The shoulder 100 in this example defines a spring stop for the bottom of the spring 38. An optional washer 102 can be seated within the open top 32 on the shoulder 100 and one end of the spring 38 can rest or bear against the washer. A fixed upper spring stop can be formed in a number of different ways, only one of which is illustrated in FIG. 5A. In this example, a fixed stop surface 104 can be molded into the connector 86 on its interior. The leg 85 can pass through an opening 106 through the stop surface 104, but the upper end of the spring 38 can bear against the stop surface. In order to fabricate and assemble the foot rest 82, the foot rest 82 can be formed as two component halves with a lengthwise parting line or separation line 108. The two parts can be configured to snap together when assembled. The foot rest 82 can be fixed in a vertical position along the legs 85 when installed around the legs 85, thus rendering the stop surface 104 a fixed stop. In another example, the foot platform can be a single molded structure attachable to separate connector parts. Alternatively, the connectors can be formed in two halves while the foot platform is one piece. One of the two connector halves can be formed integral to the foot platform and the other can be a detachable connector half.

In such an example, the housing 30 should be vertically movable or slidable telescopically relative to connector 86 in the example disclosed herein, the housing 30 can telescope within the connector 86. Also, the spring 38, because it is borne against the fixed stop washer 108, will thus bias the wheel mount 22 downward, as the spring is also borne against the washer 102 and shoulder 100 of the housing 30. During use, the wheel may encounter obstacles or uneven or rough terrain. Impact of the wheels 24 with such obstacles or terrain will cause the wheel mount to move vertically against the spring bias. The spring 38 will absorb some of the shock and dampen the movement imparted by the wheel mount 22 to the front leg 85.

As shown in FIG. 5B, the bottom end of the leg 85 can include some type of catch or stop to retain the wheel mount 22 on the front leg 85 when installed on the leg. In one example, the lower end of the front leg 85 can include a spring biased VALCO ball device having a pair of tabs or balls 110 protruding radially outward in opposite directions from the leg. The balls 110 are joined to one another by a resilient spring element 111 as is known in the art and are biased outward from the leg by the spring element. When the free end of the leg 85 clears the bottom edge 112 of the housing 30, the spring biased balls 110 will fire outward and assist in retaining the wheel mount 22 attached to the front leg 85. The VALCO balls 110 can thus act as travel limiters, restricting the downward travel of the wheel mount relative to the front leg 85. Other types of devices and mechanisms can be utilized to secure the wheel mount to the front leg 85 in place of the VALCO ball device disclosed herein, such as a cotter pin or the like.

As will be evident to those having ordinary skill in the art, various features and functions of the stroller wheel assembly 22 and system 80 can vary from the examples shown and described herein. The spring stops can vary, as can the connection between the housing 30 and connector 86. As long as the wheel mount 22 can move vertically relative to either the front leg 85 or the foot rest 82, or both, the spring 38 can perform its intended wheel suspension function. As noted above, the housing 30 and connector 86 can be telescopically arranged relative to one another to permit vertical sliding of the housing 30 into and out of the connector 86. It is also conceivable that the housing and connector 86 be connected or affixed to one another so that both the wheel mount 22 as well as the foot rest 82 move vertically in unison while the spring 38 is performing as intended. In such an example, the housing should still be permitted to swivel in some manner about the front leg 85 and also the foot rest connector 86. Similarly, relative swivel rotation between the wheel mount 22 and the front leg 85 can be created using components that differ from the components of the wheel assembly 20 disclosed and described above.

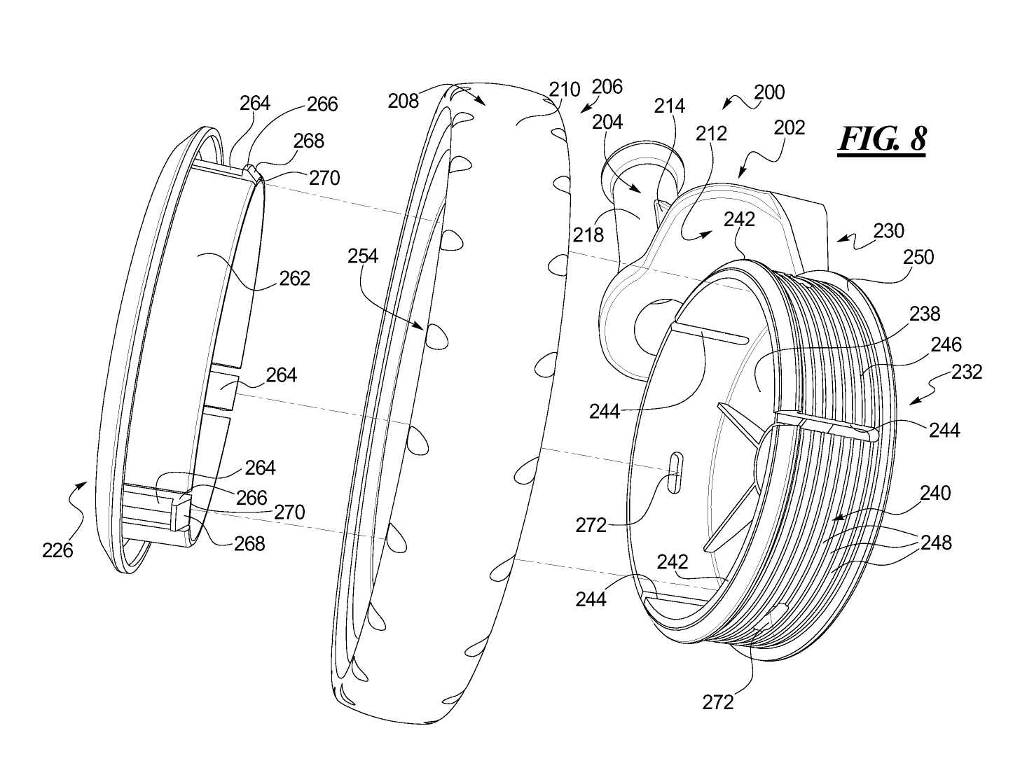

FIGS. 6 and 7 show another example of a stroller wheel assembly 200 constructed in accordance with the teachings of the present invention. In this example, the stroller wheel assembly utilizes a non-steel axle construction. The wheel assembly 200 generally has a wheel mount 202 with a housing 204 that extends upward from the top end of the mount. The housing 204 is intended to attached the wheel assembly 200 to a stroller frame part, such as a front or rear leg. The wheel assembly 200 also has a single wheel 206 that is rotatably or rollably connected to the mount 202 as described below. In general, the wheel 206 has a tire portion 208 with a tread surface 210 that faces radially outward and on which the wheel will rest and roll during use.

In this example, the wheel assembly 200 has an optional splash guard or fender 212 positioned between the housing 204 and the tread surface 210, spaced from the tread surface. The fender 212 has a width that generally matches the width of the tire portion 208 and a length that extends over a portion of the wheel circumference. The fender 212 in this example can perform the function of a splash guard or fender, but can also be configured to perform one or more structural functions. For one, the fender or guard 212 can be provided to connect the housing to other wheel mount components, as described below. For another, the fender or guard 212 can be configured to strengthen the wheel mount 202 for use. A buttress 214 extends between and connects to a top facing surface 216 of the fender 212 and to an outer surface 218 of the housing 204. The buttress 214 or other molded features can also be provided to add strength and rigidity to the wheel mount structure during use. The buttress 213 and fender 212 are optional features that can be eliminated or significantly altered within the scope of the present invention.

In the disclosed example, the tire portion 208 of the wheel 206 is mounted to a radially outward facing surface of a wheel rim 220. A plurality of radially extending spokes 222 connects the radially inward facing surface of the rim 220 to the wheel hub 224. In this example, the diameter of the hub 224 is not much less than the diameter of the rim, though it is spaced radially inward and concentric relative to the rim. Thus, the spokes 222 are quite short in this example. An outer wheel cover or 226 is secured to and covers the opening within the wheel hub 224. The opposite side of the hub 224 is also open within the interior of the hub 224 but is covered when installed on the wheel mount 202.

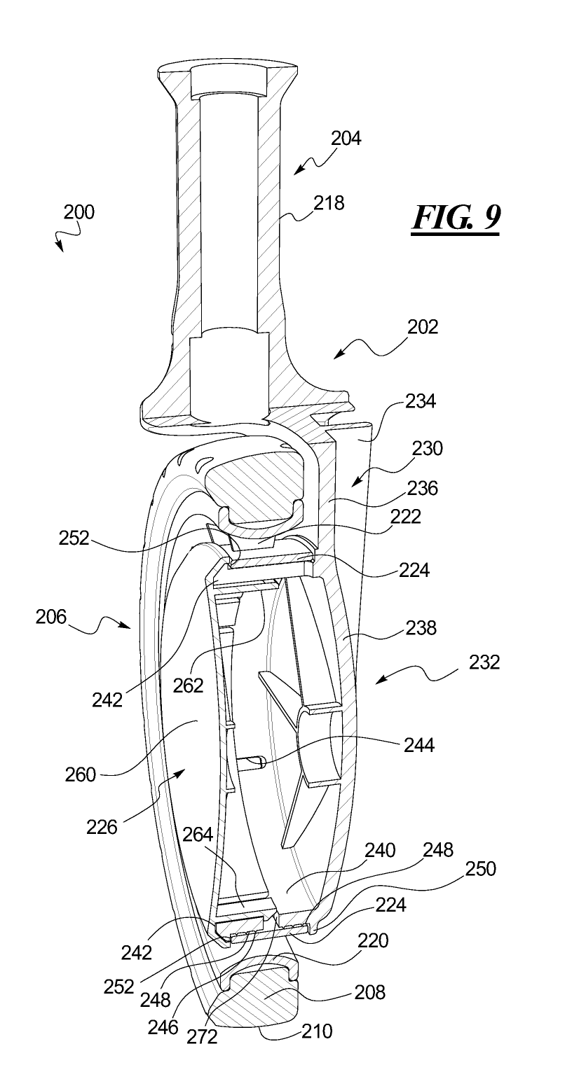

With reference to FIGS. 7 and 8, the splash guard or fender 212 is joined along one of its side edges to an integral connecting structure or axle support 230. A larger diameter axle structure 232 is carried by the lower end of the axle support 230. The axle support 230 in this example includes a plurality of elongate, adjacent ribs 234 joined to a cover plate or panel 236. The lower end of the axle support 230 is coupled to a disc 238, which has a generally circular perimeter and lies in a plane oriented generally parallel to the housing 204. The plane of the disc 238 is offset from the vertical housing axis V as shown in FIGS. 8 and 9.

The axle function of the axle structure 232 is provided by an annulus 240 that projects laterally inward from the perimeter of the disc 238. The proximal edge of the annulus 240 is integrally connected to and formed as a part of the disc 238 as shown in FIG. 9. A free edge 242 of the annulus 240 has a chamfered surface 244 defining a leading end ramp for attaching the wheel 206. A plurality of relief slots 244 are formed in the free edge 242 in an axial direction and extend toward the proximal end and the disc 238. The relief slots 244 allow the free edge 242 to flex radially inward, allowing the wheel 206, and particularly the hub 224, to be snapped over the free edge and onto the annulus 240.

An outer circumferential surface or axle surface 246 on the annulus 240 faces radially outward. In this example, a plurality of grooves 248 is formed parallel to one another and extends circumferentially around the annulus on the axle surface. A proximal shoulder 250 is positioned on the proximal edge of the annulus 240, and in this example is a continuation of the disc diameter beyond the diameter of the annulus, extending radially beyond the axle surface 246. A similar distal shoulder 252 is formed near the free edge 242 on the annulus 240. The grooved axle surface 246 is located between the distal and proximal shoulders 250, 252 and is captured between them. When the wheel 206 is pushed over the chamfered free edge 242, the free edge 242 of the annulus 240 flexes radially inward (permitted by the relief slots), which allows the wheel 206 to be pushed completely onto the axle flange. The hub 224 in this example is essentially an annular ring with a width or depth sized to fit between the proximal and distal shoulders 250 and 252. When the trailing circumferential edge of the hub 224 snaps over the distal shoulder 252, the free edge 242 of the annulus 240 returns to its normal or nominal diameter, capturing the hub 224 between the shoulders 250, 252. The radially inward facing or bearing surface 254 of the hub 244 lies against the circumferential axle surface 246 of the annulus 240 with the wheel installed.

The grooves 248 and relief slots 244 can allow air to enter, and water and other contaminants to exit from, between the hub surface 254 and the axle flange surface 246 during use. This can assist in reducing or managing surface friction between the axle surface and hub. Additionally, the grooves 248 significantly reduce the amount of surface contact between the two surfaces, thus further reducing static and sliding friction between hub and annulus or axle. Thus, the wheel 206 is free to rotate about the axle or annulus 240 during use. The annulus 240 essentially defines the axle, which replaces the steel rod axles in the prior art.

As shown in FIGS. 8 and 9, the wheel cover 226 has a generally round and planar panel 260 that covers the opening within the hub 224 when installed on the wheel assembly 200. In the disclosed example, the wheel cover 226 has an annular or cylindrical guide annulus 262 that projects in an axial direction from an interior side of the panel 260. The guide annulus 262 is sized to fit within the diameter of the axle annulus 240 when installed. The cover 226 also has a plurality of flexible fingers 264, each with a catch tooth 266 at its free end and facing radially outward. Each of the catch teeth 266 has a ramped surface 268 at its leading end 270. In a disclosed example, each of the flex fingers 264 is aligned flush with the guide annulus 262, but is separate therefrom so as to be capable of flexing as needed.

A plurality of receptacles or holes 272 are formed through the axle flange 240 and positioned to coincide with a respective one of the flex finger teeth 266 when the wheel cover 226 is oriented correctly and installed. As shown in FIG. 9, the teeth 266 snap into respective ones of the receptacles 272 to retain the wheel cover 226 attached to the annulus 240, and thus the wheel assembly 200, when installed.

The disclosed wheel assembly 200 has a simple, minimal component construction. The wheel mount 202 can be formed as a single integral plastic component, inclusive of the housing 204, the axle support 230, the fender or guard 212, the disc 238, the axle annulus 240, and the remaining structural ribs, flanges, and the like. The wheel cover 226 can also be formed as a single unitary structure, such as a molded plastic component, similar to the mount 202 Likewise, the entire wheel 206 can be molded as a unitary structure, or the hub, spoke, and rim can be formed as an integral component and a separate tire can be attached thereto. The wheel assembly 200 can thus be formed utilizing only three or four separate components, which can be easily snapped together. Similarly, the axle or annulus 240 is a sturdy, simple, lightweight, and relatively inexpensive design. The relatively large diameter of the annulus 240 creates a substantially rigid, strong, and durable structure without utilizing any steel material. The interior of the combined disc 238 and axle annulus 240 is essentially hollow, thereby significantly reducing or limiting the amount of plastic material needed to form the structure. The diameter of the annulus 240 in comparison to the diameter of the wheel 206, such as the tread surface 210, hub 224, or the like, can vary. However, in one example, the disclosed wheel assembly can function as intended if the diameter of the annulus 240 is about one half the diameter of the wheel 206 or greater than one half the diameter of the wheel, measured out to the tread surface. Testing can help one determine a particular axle annulus diameter to wheel diameter ratio, depending on the needs of a particular stroller product. The type of plastic material and the thickness of the annulus wall will also determine the necessary diameter of the annulus for a particular product.

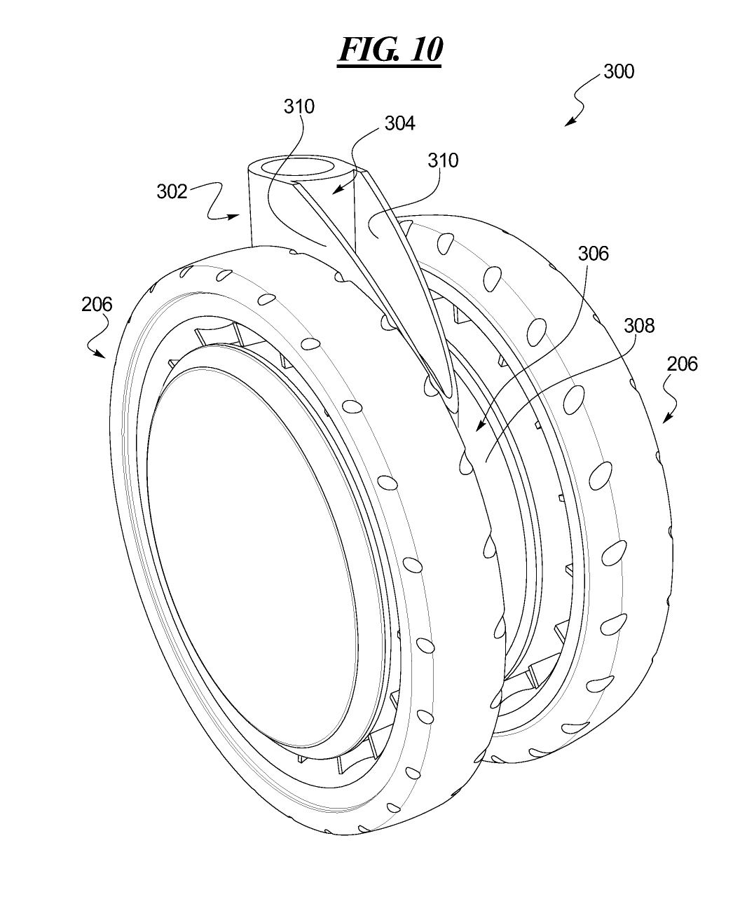

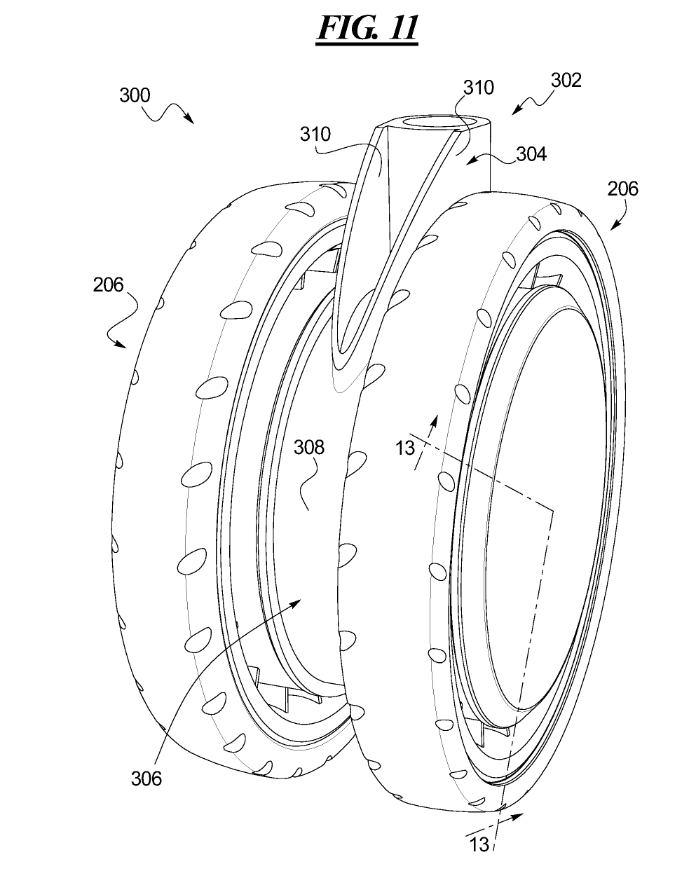

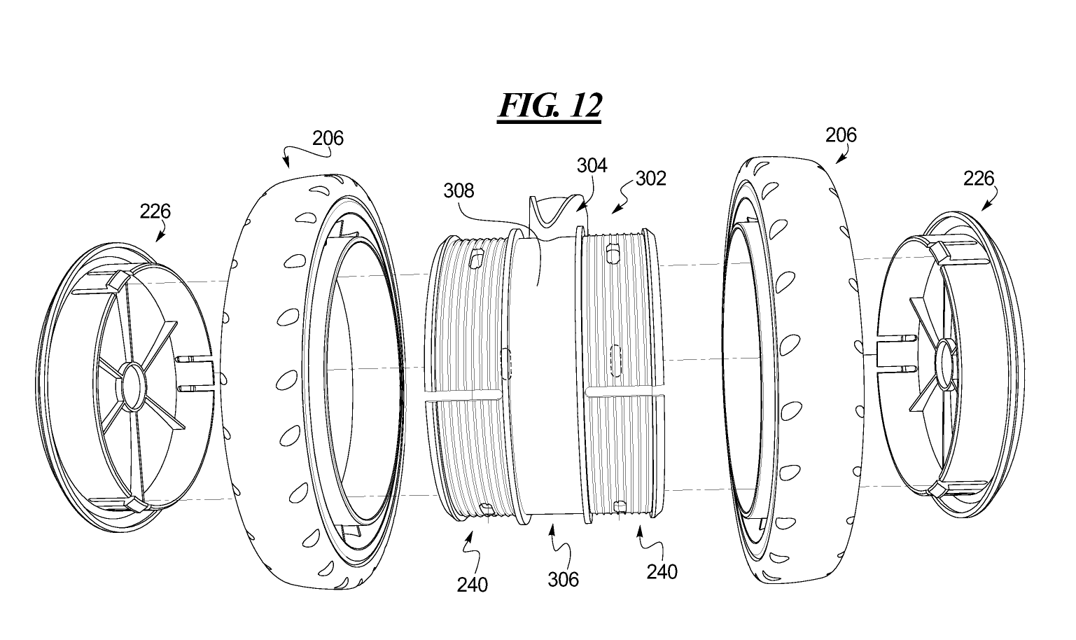

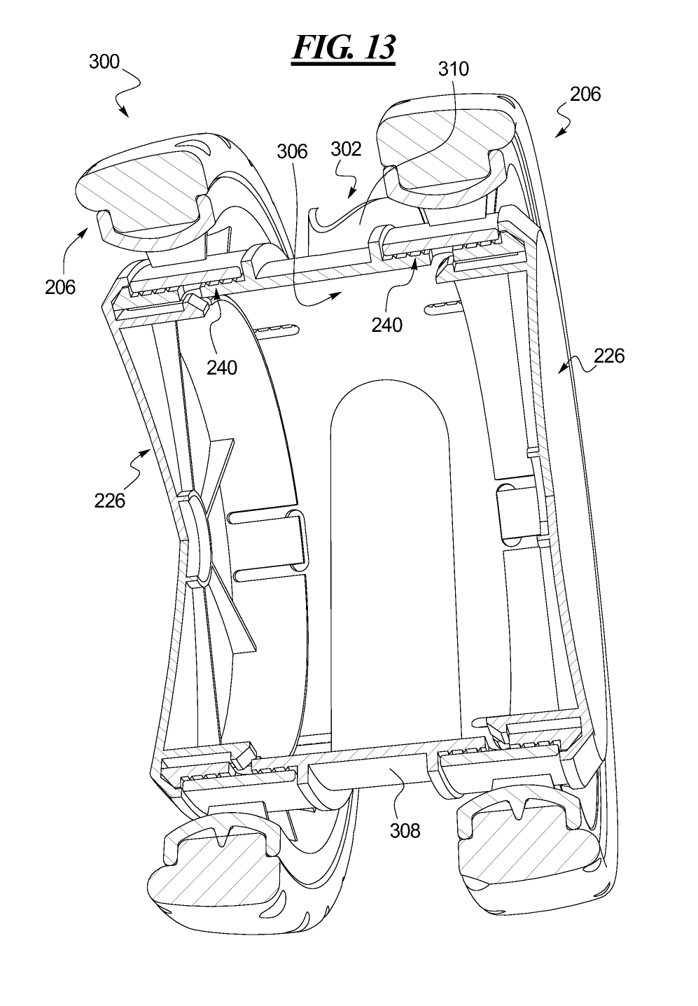

FIGS. 10-13 show another example of a stroller wheel assembly 300 constructed in accordance with the teachings of the present invention. In this example, the assembly 300 is substantially similar to that previously described with respect to the wheel assembly 200, except that the structure is a dual wheel assembly instead of a single wheel assembly. As a result, like reference numerals used with respect to this example refer to essentially identical components from the prior example. The wheels 206 are essentially identical to those previously described for the wheel assembly 200. Similarly, the wheel covers 226 are essentially identical thereto as well. Thus, details of these components are left to the earlier embodiment and not further described herein.

The wheel assembly 300 in this example includes a mount 302 with a housing 304 protruding from a large diameter axle drum 306. The housing 304 protrudes from about the middle of the axle drum 306 and is flanked on opposite sides by a pair of axle annuli 240, i.e., a pair of large diameter axles. The axles 240 in this dual wheel example are also constructed essentially identical to the annulus 240 previously described with respect to the wheel assembly 200. The only difference in this example is that the axle drum 306 has a central portion 308 from which the housing extends and to which the pair of flanking axle annuli 240 are integrally joined, formed, or connected. The disc 238 of the prior example is not present or need in this example. A different shaped buttress structure 310 is also shown that joins and strengthens or stiffens the structure of housing 304 and the axle drum 306.

In each of the stroller wheel assemblies 200 and 300, the above described simple swivel feature can be employed. Additionally, the above described internal suspension spring 38 and related components can be employed on either of the stroller wheel assemblies 200 or 300 as well. Also, the large diameter or plastic axle feature of the stroller wheel assemblies 200 and 300 can be employed on the previously described stroller wheel assembly 20 and system 80. As such, combinations of the disclosed swivel, suspension, and large axle features can be created without affecting the other features in any significant way.

The specific configuration and construction of the large axle components can vary within the scope of the present invention. For example, the manner in which the wheel covers are attached to the wheel mounts or wheels can be altered from the resilient fingers disclosed herein. The relief slots, finger receptacles, grooves, chamfered parts, annular shoulders, and the like can also vary and/or be replaced.

Although certain stroller wheel assemblies, features, and components have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A stroller wheel assembly comprising:
a wheel mount having an interior cavity and defining a generally vertical housing axis;
an axle carried by the wheel mount;
a wheel carried on the axle and rotatable about a rolling axis oriented perpendicular to the housing axis;
a leg of a stroller frame having an end section coupled to the wheel mount; and
a spring with one end borne against a spring stop on the wheel mount within the interior cavity and an opposite end borne against a fixed stop,
wherein the spring resiliently supports the wheel mount for movement against a bias force and by the bias force of the spring relative to the leg along the housing axis.

2. A stroller wheel assembly according to claim 1, wherein the wheel mount has a housing defining the cavity, and wherein the end of the leg extends through the cavity.

3. A stroller wheel assembly according to claim 2, further comprising a spring biased ball device positioned below a bottom edge of the housing retaining the wheel mount on the end of the leg.

4. A stroller wheel assembly according to claim 1, wherein the wheel mount has a housing defining the interior cavity and the housing axis, and wherein the spring stop is formed as an annular shoulder within the housing.

5. A stroller wheel assembly according to claim 1, further comprising a pair of the wheels arranged parallel and spaced apart from one another.

6. A stroller wheel assembly according to claim 1, further comprising a foot rest having an elongate foot platform and a connector at one end coupled to the leg and to the wheel mount.

7. A stroller wheel assembly according to claim 6, wherein the wheel mount can move vertically relative to the connector along the housing axis.

8. A stroller wheel assembly according to claim 6, wherein the wheel mount can swivel relative to the connector about the housing axis.

9. A stroller wheel assembly according to claim 1, wherein the end of the leg extends into the cavity along the housing axis, and wherein the wheel mount can move telescopically over the leg along the housing axis.

10. A stroller wheel assembly according to claim 1, wherein the fixed stop is carried on the leg within the cavity.

11. A stroller wheel assembly comprising:
a wheel mount having a cavity defining a generally vertical housing axis;
an axle carried by the wheel mount;
a wheel carried on the axle and rotatable about a rolling axis oriented perpendicular to the housing axis;
a leg of a stroller frame having an end connected to the wheel mount, the wheel mount capable of swiveling about the housing axis relative to the leg; and
a spring with one end borne against a housing stop within the interior cavity and an opposite end borne against a fixed stop within the interior cavity,
wherein the spring resiliently supports the wheel mount for movement against a bias force and by the bias force of the spring relative to the leg along the housing axis.

12. A stroller wheel assembly according to claim 11, wherein the wheel mount has a housing defining the cavity and the housing axis, and wherein the end of the leg extends into the cavity along the housing axis whereby the housing can swivel about the end of the leg.

13. A stroller wheel assembly according to claim 12, wherein the housing can move vertically along the end of the leg against and by the bias force of the spring.

14. A stroller wheel assembly according to claim 11, further comprising a foot rest having a foot platform and a connector at one end of the foot platform, the connector coupled to the leg.

15. A stroller wheel assembly according to claim 14, wherein the wheel mount has a housing defining the cavity and the housing axis, wherein the housing is coupled to the connector such that the housing can swivel about the housing axis relative to the connector.

16. A stroller wheel assembly according to claim 15, wherein the housing can move vertically along the housing axis relative to the connector.

17. A stroller wheel assembly comprising:
a wheel rotatable about a rolling axis and having a tread surface facing radially outward and a hub surface facing radially inward;
a fixed axle formed of a plastic material and having as an annulus with a proximal edge connected to a disc, a free edge, and a generally open interior within the annulus, the annulus defining an axle surface facing radially outward,
wherein the wheel is mounted on the annulus such that the axle surface is borne against the hub surface, the wheel being rotatable about the rolling axis relative to the axle surface.

18. A stroller wheel assembly according to claim 17, wherein the diameter of the axle surface is about equal to or grater than one half the diameter of the tread surface.

19. A stroller wheel assembly according to claim 17, further comprising a plurality of grooves formed in and circumferentially around the axle surface on the annulus.

20. A stroller wheel assembly according to claim 17, wherein the annulus of the fixed axle has a chamfered leading edge and has at least one relief slot formed into the leading edge to assist in snapping the wheel onto the fixed axle.
